(19) United States
(12) Patent Application Publication
(10) Pub. No.: US 2013/0154795 A1
(43) Pub. Date: Jun. 20, 2013

(54) DATA MEDIUM FOR THE CONTROL OF ENTITIES, AND DEVICE AND METHOD FOR THE CONTROL OF ENTITIES

(71) Applicants: Franklin Devaux, Prenois (FR); Patrick Vassort, Paris (FR)

(72) Inventors: Franklin Devaux, Prenois (FR); Patrick Vassort, Paris (FR)

(73) Assignee: CITIZENGATE, Paris (FR)

(21) Appl. No.: 13/635,252

(22) PCT Filed: Mar. 15, 2011
(86) PCT No.: PCT/FR2011/000140

§ 371 Date: Mar. 8, 2013

(30) Foreign Application Priority Data
Mar. 15, 2010 (FR) 10/01032

(51) Int. Cl. G06K 7/00

(52) U.S. Cl. CPC G06K 7/00
USPC 340/5.65

(57) ABSTRACT

The invention relates to a data medium (1) comprising an electronic chip provided with an identity zone storing identity data relating to the entity (6a, 6b) and a group zone storing group data relating to the membership of the entity (6a, 6b) to at least one group (5a, 5b). The invention also relates to a device (10) for controlling entities, comprising: data media (1); an identity control unit (11) enabled and able to recognize the identity data; an updating unit (12) enabled and able to update the group data as a function of the movement of the entity (6a, 6b) from one group (5a, 5b) to another, in order to generate a log; a group control unit (13) authorised and able to control the group data of each entity (6a, 6b); and alert means that can be triggered as a function of said controlled group data.

### TECHNICAL FIELD

This invention relates to a data medium for the control of entities, a device and a method for the control of entities intended to use such a data medium, in particular at the territorial boundaries of a state, for controlling the origin and history of different movements of people seeking to enter the state concerned, or the destination and validity of the visa if required of people leaving the state concerned.

### PRIOR ART

Data media and entity control devices are commonly used in different fields, such as, for example, control of access of entities to places or to services, selection of entities or simple identification of entities. The controlled entities may be individuals, animals or objects. The data media and devices for control of entities are, for example, used at the territorial boundaries of states, in particular to manage access of entities to means of transport such as road, rail, air and sea. The data media are generally individually assigned to the entities. Each data medium comprises, for example, a smart card of which the electronic chip contains, in encoded or non-encoded form, the recording of data relating to the identity of the entity. In the description below, the term electronic chip refers to a miniature electronic circuit of the microprocessor type.

Other types of data such as, for example, specific access rights, can also be recorded on the data medium. At predetermined or randomly defined control points, the entities are controlled by means of their data medium. The identity of the entity and his, her or its right of access to a specific area, or his, her or its right to leave or to enter a territory, for example, is then verified. The controls performed may be performed by control agents, automated systems or any combination. The data media may also comprise biometric data making it possible to verify that the entity carrying the data medium corresponds to the entity registered as the owner of the data medium. Identity theft is thus avoided.

In the field of airline transportation, data media and control devices make it possible in particular to ensure that the travelers boarding the airplane correspond to the travelers indicated, and that they have certification of payment for the corresponding transport ticket. Data media are also used to authorize access to dedicated spaces, for certain categories of travelers, in which dedicated spaces they may in particular have access to better comfort.

When the travelers depart, the access control performed in the boarding area is generally performed by a control agent who verifies the identity of each traveler, for example by means of his or her identity card or passport. The control agent then provides a boarding card, which the traveler keeps with him or her. This boarding card generally shows data relating to the traveler's identity and thus making a subsequent control possible. This boarding card is a paper document or, as described in the publication FR 2 891 640, a smart card equipped with an electronic chip.

In the publication FR 2 891 640, the smart card has a side having a permanent imprint and a side having an erasable and rewritable imprint, making it possible, in particular, to update the boarding card in the travelers successive boardings. In the case of smart boarding cards, they may also comprise biometric data enabling real-time verification that the traveler presenting it is indeed registered as the owner of the boarding card.

Before authorizing the boarding, the control agent performs a document comparison between the boarding card and a form of identification (identity card, passport, etc.) of the traveler. With an increasing number of travelers, these document comparisons are increasingly time consuming and tedious to perform. Moreover, they require each traveler to repeatedly handle his or her official documents and boarding card, producing a risk of loss of loss and damage to the documents and boarding card. Therefore, smart boarding cards are increasingly preferred because they make it possible to limit the risks of falsification associated with paper documents, avoid damage to the data medium, and they are more practical to handle, resulting in improved comfort for travelers. They also enable significant paper savings.

When the boarding card is a smart card, the control before boarding may be performed entirely or partially by automated means, for example by means of an automatic control portal. When the traveler arrives at this automatic control portal, he or she presents his or her boarding card to a reading zone capable of controlling the access information present on the chip of the boarding card. The traveler presents one of his or her eyes/one of his or her fingers before an identification zone capable of verifying, in real time, that the eye/fingerprint of the individual presenting him or herself at the control and that of the holder of the boarding card match.

When the travelers arrive, for example at airports, the origin of the travelers may be verified so as to determine whether a specific access control and/or specific surveillance of certain travelers should be implemented. This is, for example, the case when travelers come from so-called “sensitive” geographic territories in which acts of terrorism are common, or known to be affected by drug trafficking. This verification makes it possible to determine the origin of the traveler as well as the states in which this traveler has previously traveled and/or stayed. This verification is performed manually by a control agent, who consults the passport of each traveler, takes note of the different stamps previously imprinted on the passport by the different territorial authorities who previously validated the entry of the traveler into their territory. According to the instructions received as well as the security measures in force, depending on the information obtained from this verification, the control agent will direct the traveler to a more in-depth control or will validate and authorize the passage of the traveler, who will then be free to enter the geographic territory of the state. The control agent may also notify other security services of the passage of a traveler needing additional surveillance. With the current means, the verification of the origin and the course of each traveler is a time-consuming and tedious operation that results in long traveler waiting lines. In practice, to avoid the congestion of arrival and control areas for incoming travelers, and to limit the dissatisfaction and discomfort of travelers, it is common for all of the travelers not to be controlled and for the verifications to be performed only sporadically, for example by random statistical control. It is also common for the controls to be performed more hastily than they should be, to the detriment of their reliability and quality. In addition, the verification of the entry of individuals at state borders is not optimal and does not enable a satisfactory filter to be implemented. In group transports, in particular in air transport, the verification of the origin and prior course of travelers does not currently make it possible to satisfactory limit the risk of attacks during travel. Indeed, these verifications face the same pitfalls as those implemented when individuals enter a state.

There is therefore a need for a data medium, a device and a method for controlling entities making it possible to preserve a reliable and precise history of the belonging of the entity to different groups so as to enable reliable, fast and systematic control of this history, in particular to verify the origin of travelers, their prior course and adopt appropriate measures depending on each case.

### DESCRIPTION OF THE INVENTION

This invention is intended to overcome these disadvantages by providing a data medium, a device and a method for controlling entities making it possible to control entities, in particular travelers, in an effective, reliable, systematic and at least partially automated manner, on the basis of their origin and the different states through which they have traveled during their trip, or in the past, while respecting the individual liberties and the confidentiality of the data relating to each entity. The data media, device and method according to the invention are thus intended to provide technical means for following the history of movement of a traveler and better target and manage the potential risks represented by travelers coming from so-called “sensitive” countries.

The invention relates to a data medium comprising at least one identity zone capable of storing identity data relating to the identity of the entity to which is intended to be assigned, wherein the identity data is capable of being accessible only by at least one qualified identity control unit. The control may thus be performed automatically, semi-automatically and supervised by a control agent, or manually. This data medium is remarkable in that it comprises at least one electronic chip equipped with at least one group zone capable of storing group data relating to the belonging of the entity to at least one group, the group data being protected by at least one gate so as to be accessible only by at least one qualified group control unit having an access key for said gate, the group zone being capable of being updated only by means of a qualified updating unit having an access key for said gate, with the updating being performed by the addition of at least one complementary group data item incrementing, without altering, said group data previously stored on the basis of the entity's passage from one group to another group so as to generate a history of belonging of the entity to successive groups, with the group zone being capable of preserving the history. This data medium thus makes it possible to preserve a reliable and precise history of the belonging of an entity to different successive groups so as to enable an effective, reliable and systematic control of his or her belonging to these different groups. In the particular case of traveler control, the data medium makes it possible to preserve the history of the different states through which the traveler has traveled, the different visas possibly used, and to control the origin of the traveler. As access to identity and group data is possible only for qualified entity, group and updating control units, the group and identity data are thus preserved on the data medium, without the creation of an external database, out of respect for the individual liberties and the confidentiality of data relating to each entity.

The electronic chip is preferably arranged so that the gate protecting access to group data is chosen from the group including at least an optical gate, a magnetic gate or an electronic gate, these gates being capable of being opened by an optical, magnetic or electronic key, respectively.

According to a preferred embodiment, the electronic chip is an RFID chip equipped with the electronic gate.

Advantageously, the group zone is arranged so that the group data is accessible by the qualified group control unit, independently of the identity data. This design makes it possible to ensure the confidentiality of the identity data and the group data, which are thus accessible only by qualified individuals.

The group zone is preferably capable of storing the group data incrementally, permanently and inalterably. The history thus created makes it possible to reliably preserve the traceability of the belonging of each entity to different groups.

The identity and group zones may be distinct. By distinct, we mean that the identity and group zones may be combined in the same zone, the same location, on the data medium, but be distinct in their mode of access (gate or other) and/or their operation and/or any other means enabling it to be made distinct. It is thus possible, in a distinct and sequenced manner, to access the information recorded in the group zone and that recorded in the identity zone. The identity data can then remain inaccessible during the control of group data, and conversely for group data during the control of identity data. The confidentiality of individual data is thus preserved. By extension, the term “distinct zones” also means identity zones and group zones that have different locations, whether or not these distinct identity zones and group zones are on the same electronic chip.

According to a preferred embodiment of the invention, the data medium comprises at least one electronic chip equipped simultaneously with at least one of the identity or group zones.

The data medium can be chosen from at least:
a smart card, a passport (for example, electronic), a telephone, a bracelet, a watch, a collar, a tag intended to be worn by said entity, or
an implant, intended to be inserted into said entity or into an object associated with the entity, such as, for example, an item of clothing.

The group referred to above and on which the group data is based preferably consists of entities having been present, at a given time, in a given geographic territory, and the updated group data preferably relates to the crossing by an entity of the territorial boundary of each geographic territory, and all of the group data preferably constitutes a history of the territorial boundaries crossed.

Similarly, the group data is advantageously chosen from a group including at least a state logo, the ICAO code of an airport, and the date of update. Thus, the ink stamp generally used on passports is in this case replaced by an electronic stamp making it possible to preserve the history of all of the states visited by each traveler or through which the traveler has traveled, and thus to authorize or not the entry of this traveler into another state and/or to apply a suitable level of vigilance and/or appropriate security measures.

The updated group data may also comprise, in addition, the date of its update on the data medium.

The invention also relates to an entity control device comprising a plurality of data media, each data medium comprising identity data relating to the entity to which it is assigned, said device comprising control means equipped with at least one identity control unit and capable of accessing the identity data. The control of the identity can thus be performed automatically, or semi-automatically and supervised by a control agent, or manually. This device is remarkable in that it comprises a plurality of data media as described above, at least one qualified updating unit comprising an access key for the gate protecting access to group data capable of updating the group data by the addition of at least one complementary group data item incrementing, without altering, the group data previously stored, on the basis of the passage of the entity from one group to another group so as to generate a history of belonging of the entity to successive groups, with the history being preserved by the group zone. The updating of group data can thus be performed automatically, or semi-automatically and supervised by a control agent, or manually. This device is also remarkable in that the control means also comprise at least one qualified group control unit comprising at least one access key for the gate protecting access to group data, wherein the control unit is at least partially automated and capable of accessing the group data of each entity and of controlling it. The device is finally remarkable in that it comprises, in addition, alert means coupled at least with the group control unit and capable of triggering an alert on the basis of the group data controlled by the group control unit. The group data control can thus be performed automatically, or semi-automatically and supervised by a control agent, or manually. This device according to the invention thus makes it possible to reliably and effectively preserve and verify the history of belonging of entities to different successive groups so as to enable effective, reliable and systematic control of their present or past belonging to these different groups, while respecting individual liberties and the confidentiality of data relating to each entity.

The access key for the updating unit and the group control unit is preferably chosen from the group including at least an optical access key, a magnetic access key or an electronic access key capable of opening an optical, magnetic or electronic access gate, respectively.

At least one among the updating unit or group control unit advantageously comprises an RFID microprocessor equipped with the electronic key.

The updating unit is advantageously geographically remote from the group control unit.

Preferably, the updating unit and the group control unit are respectively provided in at least one entity passage location leading to the entry into/departure from at least one first/second geographic territory, with each geographic territory defining one of the groups. This entity passage location is, for example, chosen from at least airports, ports, train stations and road border stations.

The group control unit is advantageously coupled with blocking means capable of preventing the passage of the entity from one group to another group on the basis of controlled group data. These blocking means are, for example, chosen from the group including at least a door, a barrier or an airlock.

The identity control unit is advantageously combined with at least one of the group control and/or updating units. This configuration thus makes it possible to simultaneously control the identity and the group of the entity or to control the identity while updating the group data of the same entity.

The invention finally relates to a method for controlling entities in which at least one entity is assigned at least one data medium comprising data relating to the identity of the entity. This method is remarkable in that a data medium and a device as described above are used, and in that the method also comprises at least the following steps:
the updating, recording and storage on the data medium of group data relating to the change in group of the entity, in order to create, by means of updates, a history of the groups to which the entity has belonged,
the control and filtering of group data of the entity in order to verify the history of the group data and, on the basis of the controlled group data, to validate the control or not.

This method makes it possible to reliably and effectively preserve and control the history of belonging of the entity to different successive groups so as to enable an effective, reliable and systematic control of his or her belonging to these different groups, while respecting individual liberties and the confidentiality of data relating to each entity. It is thus possible to take the appropriate measures as a result of the control of the history of belonging to different groups or to certain specific groups.

Preferably, at least one of the updating, control and filtering steps is performed at an entity passage location, leading to the entry into/departure from at least one first/second group. When the groups define individuals present in a given geographic territory, this passage location is, for example, an airport, a port, a train station, or a road border station. The history of group data is thus more reliable than if the update took place in the group, for example in the geographic territory by means of a random update. Similarly, the security of the group, for example, the inhabitants of a geographic territory, is better reinforced by controls performed upon entry into the group, for example at the borders of the geographic territory, than by random controls that would be performed in the group, in the geographic territory. There is indeed a risk in this case of re-controlling individuals who have already been controlled, and that other non-controlled individuals are never controlled.

The method advantageously includes at least one preliminary step of defining criteria during which control criteria for positive/negative admissibility of an entity in a group are defined. In addition, in the filtering step, it is not possible to validate, without an additional step, the passage of entities of which the controlled group data do not correspond/correspond to the control criteria for positive/negative admissibility.

When the controlled group data are not validated, at least one of the following steps is advantageously performed:
the change in group by said entity is blocked,
an alert signal is transmitted.

### BRIEF DESCRIPTION OF THE DRAWINGS

The invention is described below, by way of a non-limiting example, in reference to the appended drawings wherein:

FIG. 1 shows a diagrammatic view of a data medium according to the invention, which data medium comprises an identity zone and a group zone; this figure details, on the right-hand side, a portion of the possible content of the identity zone linked for greater clarity to the data medium by a dotted line;

FIG. 2 is a diagrammatic view of the entity control device according to the invention;

FIG. 3 is a diagrammatic view of a first application of data media, device and entity control method according to the invention;

FIG. 4 is a diagrammatic view of a second application of data media, device and entity control method according to the invention;

FIG. 5 is a diagrammatic view of a third application of data media, device and entity control method according to the invention.

The various embodiments detailed in the description below focus on the use of data media, an entity control device and the implementation of such a device by an entity control method, applied to individuals, in particular to travelers, in order to manage the territorial entries and departures of these travelers, in particular at airports. It is understood that, more generally, the term entity applies to an individual, to an animal or to an object, and that the invention is not limited to its application in airports, but is envisaged in any other control configuration. Similarly, a data medium in the form of a smart card is described below. It is understood that the data medium may be of another type, for example:
an electronic passport, a telephone, an electronic bracelet, a watch, worn by an individual,
a collar worn by an animal,
a tag affixed to an object,
an implant inserted into the body of an individual, an animal or in an object.

The implant may, for example, be inserted into the uniform of a security agent, a navigation agent or a member of the military for the purposes of managing dedicated access and the history of movements of these individuals.

The data medium may comprise data visible to the eye and invisible data, in particular data for optical reading (MRZ zone, 3D bar code), for magnetic reading, for electronic reading (RFID, NFC, Wi-Fi, Bluetooth, LAN, WiMAX, Skype, GSM, etc.) or any combination.

### PREFERRED EMBODIMENT OF THE INVENTION

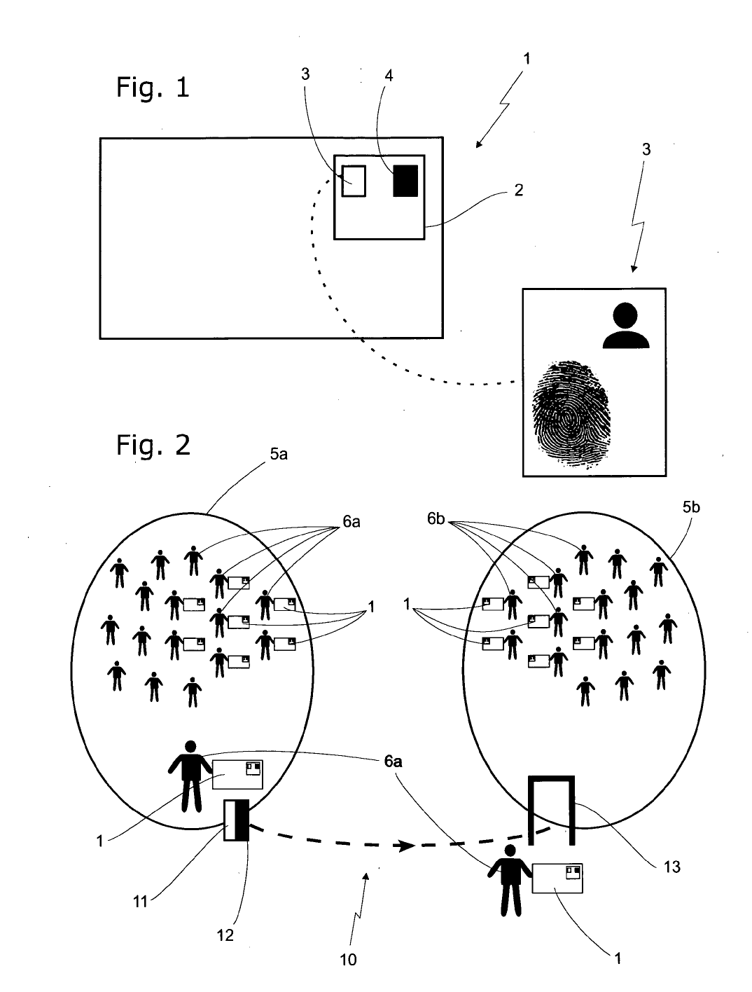

In reference to FIG. 1, the data medium 1 according to the invention is in the form of a smart card. This smart card 1 is, for example, rewritable, like that described in the publication FR 2 891 640. It may comprise information one or both of its sides. Among the rewritable information that the smart card 1 may comprise are, in particular, information relating to the boarding of the traveler, such as in particular the flight number, the reserve seat, and the scheduled departure time. The smart card 1 comprises an electronic chip 2 diagrammatically represented by a rectangle. This electronic ship 2 may be visible and apparent on one or both sides of the smart card 1. It may also be invisible, for example embedded in the body of the smart card 1.

The electronic chip 2 comprises an identity zone 3 capable of storing identity data relating to the identity of the entity to which the data medium 1 is intended to be assigned. This identity data comprises, for example, the last name, the first name, the birth date, the biometric imprint of one or more fingers or of the eye, or a photograph of the face or the head. In the case of an animal, this identity data may comprise the birth date of the animal and its breed. This identity data is recorded by the electronic chip 2 and stored in the identity zone 3. The identity data is encoded by traditional means so as to make its access by unqualified means difficult.

The control of the identity data may be performed manually, automatically or semi-automatically. In addition, it may be performed absolutely, by comparison, by matching or by any combined method. In the case of absolute control, the identity data is examined individually so as to make sure that there is no abnormality. In the case of a control by comparison, the identity data is compared to identity data previously stored and accessible by the group control unit. In the case of a control by matching, the identity data is compared to the entity presenting him or herself at the control, for example by a real-time comparison of the photograph or the imprint stored among the identity data with that of the physical entity. For the biometric data control, specific biometric capture equipment is used, making it possible to capture the biometric imprint of the individual presenting him or herself at the control and to compare it in real time with the biometric imprint stored among the identity data. The identity data is stored permanently and inalterably or so as to be capable of being modified (change of nationality, etc.). To this end, as described below, the data control device may comprise an updating unit (not shown) intended to update the identity data.

The electronic chip 2 also comprises a group zone capable of storing, permanently and inalterably, group data relating to the belonging of the entity to a group. The group data relates, for example, to the belonging to the group consisting of individuals having been present, at a given time, in a given geographic territory. To this end, the group data may comprise the code of a geographic territory, a state logo, the ICAO code of departure airports, thus indicating the origin of each individual and the airports through which he or she has traveled. In the description below, the term territory refers to a geographic territory. In the case of an animal, this group data may comprise the references of a livestock inventory, a geographic origin, references of a herd, or the contact information of a farm.

This group data is recorded by the electronic chip 2 and stored in the group zone 4. As detailed below, this group data is intended to be updated as the entities move, from one group to another, so as to preserve, in the group zone 4, a precise history of the belonging of the entity to his, her or its successive groups. To this end, the group data includes the date of the update of the group data. The group data is encoded by traditional means so as to make its access by other non-qualified means difficult.

The identity/group data is stored in the identity 3/group 4 zone, respectively, so that it can be recognized by a qualified identity/group control unit, each capable of reading the identity/group data and authorizing its control. The smart card 1 preferably comprises an electronic RFID-type chip 2, with the access to the stored data being protected by an electronic gate so that it is accessible only by RFID or equivalent qualified communication means, i.e. having an electronic key for access to the electronic gate. In other examples, the access to the identity and group data of the electronic chip is protected by an optical gate or by a magnetic gate. In these cases, the identity and group data stored in the electronic chip will be accessible only by identity or group control units comprising an optical or magnetic key compatible with the optical or magnetic gate.

According to an alternative embodiment not shown, the data medium may comprise a plurality of electronic chips each dedicated to an application. It is thus possible to provide one electronic chip dedicated to identity data and another electronic chip dedicated to group data. The identity and group zones are thus physically distinct and remote.

According to an alternative embodiment not shown, the data medium comprises a plurality of identity zones and/or a plurality of group zones, wherein each of these zones is, for example, intended to be used by a specific application. Thus, according to the application and the control means, certain identity or group data will remain inaccessible during the control of the group or identity data, respectively, with this identity or group data thus remaining confidential.

The data medium may also comprise other data zones, for example relating to health, access rights, advantages acquired or any other information that may be used for the control and/or identification of the entity. These other data zones are integrated with the electronic chip comprising the identity and group zones or with a complementary electronic chip.

In addition to the data zones described above, the data medium may comprise other data, for example by means of an inscription, a 3D bar code, an MRZ zone (Machine Readable Zone), or a magnetic strip.

FIG. 2 shows a first preferred embodiment of the entity control device 10 according to the invention. To illustrate this first embodiment, in this example, two distinct groups 5a, 5b of individuals 6a, 6b are considered, wherein each individual 6a, 6b defines a distinct entity. Each group 5a, 5b consists of individuals present in a given territory. The first group 5a thus consists of individuals 6a present in a first territory. Some of the individuals 6a of the first group 5a individually wear a data medium 1 as described above. The other individuals 6a do not have a data medium according to the invention. The same applies to the individuals 6b of the second group 5b. The data media 1 may be assigned as requested by individuals 6a, 6b wanting to change territories, whether this change is temporary or permanent. The data media 1 may also be created uniquely and anticipated and assigned in advance to each individual 6a, 6b. Thus, each individual 6a, 6b may be assigned a data medium 1 that will follow him or her throughout his or her life. Each individual 6a, 6b may also be assigned a plurality of data media 1 that he or she will use successively, with each data medium 1 being capable of having a predetermined validity period different from that of the other data media 1. Each individual 6a, 6b may finally be assigned a plurality of data media 1 that he or she will use simultaneously or successively, with each data medium 1 being, for example, dedicated to one or more applications different from those of the other data media 1.

The device 10 comprises an identity control unit 11 making it possible to perform a control by comparison of the identity data and thus to verify, in real time, that there is indeed a match between the identity data of the data medium 1 and the individual 6a, 6b wearing the data medium 1. In this example, this identity control unit 11 is automatic and is provided at the departure from the first territory, at which departure the individuals 6a, 6b wanting to leave the first territory in question and therefore the first group 5a are present.

The device 10 also comprises at least one updating unit 12 making it possible to update the group data 4 by indicating the departure from the first territory and therefore the fact that the individual 6a, 6b has left the first group 5a. In this example, this updating unit 12 is automatic and provided at the departure from the first territory and combined with the identity control unit 11. This updating unit 12 therefore makes it possible to record, in the group zone 4, permanently and inalterably, the data relating to the fact that the individual 6a, 6b is leaving the first territory and therefore the first group 5a. This data comprises, for example, the time and date of crossing of the border delimiting the first territory, the location of crossing of this border, and the identification of the first territory. The group data can also be completed with the traveler's destination, the type of document used by the traveler for authentication, the type of visa used if required to enter the country, the type of transportation used (road, air, rail or sea), the reference of the road, air, rail or sea transport, and the identification of the vehicle. This data may be borne by the electronic chip 2, a bar code, an MRZ zone or any other suitable means. The device 10 may of course comprise a plurality of updating units 12, including, in particular, a second updating unit (not shown) provided at the entry into/departure from the second territory and making it possible to record, in the group zone 4, data relating to the fact that the individual 6a, 6b is entering/leaving the second territory. In each update, the group data is preserved in the group zone 4 without altering the group data previously recorded. Thus, the group zone 4 contains the history of the different group data, updated as the group 5a, 5b of the individual 6a, 6b changes.

The device 10 finally comprises at least one group control unit 13 making it possible to control the group data 4 of the individuals 6a, 6b presenting themselves at the entry to the second territory and therefore of the second group 5b. In this example, this group control unit 13 is automatic and provided at the entry to the second territory and is capable of controlling the updated group data, in particular by the updating unit 12 at the departure from the first territory. This group control unit 13 is of course capable of controlling the entire history of the successive updates of group data. The group control unit 13 may also be combined with an identity control unit (not shown) making it possible to verify the identity of the individual 6a, 6b at the entry to the second territory. Similarly, as described below, the group control unit 13 may be coupled to blocking means, for example, a door, a barrier or an airlock, capable of preventing an individual 6a, 6b from passing into the second territory on the basis of controlled group data.

Advantageously, the group data is accessible independently from the identity data. It is then possible to control the group data alone without having access to the identity data, and vice versa. The rights of access to the different data can thus be assigned discriminately so as to authorize access to personal and/or confidential data only to individuals specifically qualified to consult it. Thus, the confidentiality of personal data is preserved.

The entity control device 10 may of course comprise a plurality of group control units 13 including, in particular, a second group control unit (not shown) provided at the entry to the first territory and making it possible to control the group data of individuals 6a, 6b presenting themselves at the entry to the first group 5a, for example coming from the second territory. The device 10 according to the invention can comprise a greater number of identity 11/group 12 control units and updating units 12. Each territory and group 5a, 5b can thus have a plurality of these identity 11/group 13 control units and updating units 12, arranged at locations for passage of individuals 6a, 6b leading to the entry into/departure from the territory in question, for example in airports, ports, train stations and road border stations. Of course, only the individuals 6a, 6b having a data medium 1 according to the invention may benefit from the advantages of the device 10 according to the invention. It is understood that the automation of control operations makes it possible to perform them at a higher speed than when they are, entirely or partially, performed by a control and updating agent. In addition, the automatic means make it possible to make the controls performed reliable by reducing the risks of human error and the subjective nature of the interpretation of differences and resemblances in particular between a photograph and a face and by increasing the analysis capacities.

As shown below, the device 10 according to the invention may comprise alert means coupled to the group control means and capable of triggering an alert if the controlled group data corresponds to predetermined criteria.

Still in reference to FIG. 2, the entity control method making it possible to implement the data medium 1 and the entity control device 10 as described above will be described below. First, a data medium 1 is individually assigned to individuals 6a of a first group 5a (first territory). When one of the individuals 6a wants to leave this first group 5a, he or she presents him or herself at a border of the first corresponding territory equipped with control means comprising in particular an identity control unit 11. The identity data of the individual 6a, stored in the identity zone 3 of the data medium 1, is controlled by the identity control unit 11. When the data medium 1 is of the RFID type, an identity control unit 11 comprising an RFID transmitter is used. If the identity data or the actual identity of the individual require it, an alert is automatically triggered by the identity control unit 11 so as to alert the competent authorities who may then respond.

In addition, an updating unit 12 for updating the group data contained in the group zone 4 is used by indicating that the individual 6a is “departing” from the first group 5a. When the data medium 1 is of the RFID type, an updating unit 12 comprising an RFID transmitter is used. The data indicating that the individual 6a is “departing” from this first group 5a is equivalent to that indicating that the individual has been present in the first territory until the date of updating of the group data. If the individual 6a is leaving a territory, and in particular the first group 5a, for the first time, the data concerning his or her departure from the first group 5a will be the only data available in the group zone 4. If, by contrast, the individual 6a has already traveled through one or more other territories or stayed in these other territories, and therefore belonged to other groups, the group data concerning his or her departure from the first group 5a will be added, distinctly, to the other group data previously recorded, without altering this other group data. Thus, the data medium 1 preserves an unaltered and inalterable history of all of the territories through which the individual has traveled, with each of these group data items being individually controllable.

When the individual 6a who has left the first group 5a wants to enter the second group 5b, he or she presents him or herself at the border of the second corresponding territory, equipped with a group control unit 13. This group control unit 13 controls the group data recorded in the group zone 4 of the data medium 1. To do this, the group control unit 13 accesses, in reading mode, the group data using the access key of the gate protecting the group data. The group control unit 13 then performs a filtering operation consisting of verifying whether the group data present in the history responds to the admissibility control criteria previously established. When the data medium 1 is of the RFID type, a group control unit 13 comprising an RFID transmitter-receiver equipped with an electronic key is used.

The admissibility control criteria may be positive criteria corresponding, for example, to the fact that an individual 6a, 6b belonged to a specific group 5a, 5b, for example, was present in a determined territory. These admissibility control criteria may also be negative criteria corresponding, for example, to the fact that an individual 6a, 6b did not belong to a specific group 5a, 5b, for example, was not present in a determined territory. The admissibility control criteria may be conditional and require, in order to be satisfied, a match with a complementary condition, for example the presence or absence of the individual 6a, 6b, in a determined territory, before or after a determined date or during a determined period. The admissibility control criteria may also be sequential and require, in order to be satisfied, that the individual 6a, 6b was present in certain territories according to a pre-established order of his or her presence in these territories.

If the group data is validated, after comparison with the admissibility control criteria, the entry of the individual 6a into the second group 5b is authorized. If the group data is not validated, it is not possible to validate, without an additional step, the entry of the individual 6a into the second group 5b. The additional step may consist of authorizing the entry of the individual 6a after launching an additional operation. According to the control location, a plurality of operations may be launched. It is possible, for example, to physically block the individual 5a, 5b so as to prevent him or her from entering the second territory during a period of in-depth verifications and/or to transmit an alert signal so as to warn the competent authorities to implement suitable measures for surveillance of the individual 6a in the territory.

Upon arrival in the second group 5b, the identity data may also be controlled by an identity control unit not shown.

The device 10 operates similarly when an individual 6b goes from the second group 5b to the first group 5a. For greater clarity, the updating, entity control and group control units corresponding to this reciprocal operation have not been shown.

In an alternative embodiment not shown, a group control unit is used at the departure of the first territory. Thus, if the group data is not validated upon departure from the first territory, the individual cannot leave the first territory in question without accomplishing an additional step. This additional step may, for example, consist of recording specific alert information on the data medium. The fact that an individual can be prevented from leaving a particular territory makes it possible in particular to limit the risks of an attack during the travel of other individuals. This security aspect is particularly important for trips of individuals in a group, in particular by airplane.

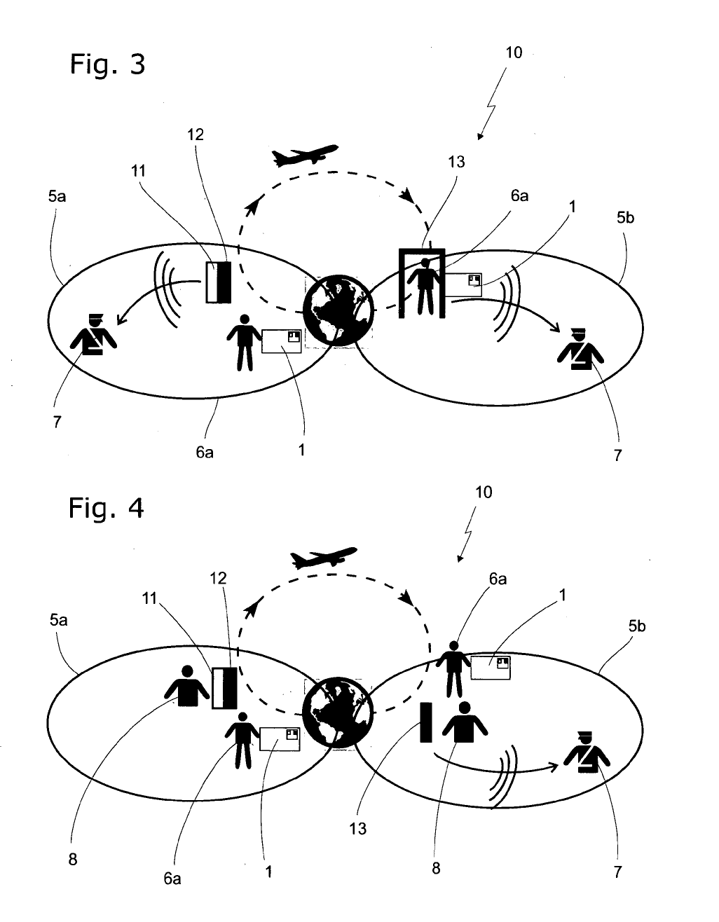

FIG. 3 shows an application of the entity control device 10 of FIG. 2 in the airplane transport of travelers 6a, wherein this transport takes place between a first given geographic territory (first group 5a) and a second given geographic territory (second group 5b). In this application, each traveler 6a is therefore considered to be an entity. On departure, each traveler 6a presents him or herself at a control area, provided at the departure from the first group 5a, and at which he or she submits his or her data medium 1 to the control. The identity data is thus controlled, before the departure from the first group 5a, by the identity control unit 11. This identity control unit 11 is automatic. In the event of an abnormality detected by the identity control unit 11, it implements alert means so as to warn a security agent 7, who intervenes so as to take the appropriate measures for the situation. In addition, the group data is updated by the updating unit 12. This updating unit 12 is also automated and enriches the group data history by indicating that the traveler 6a is leaving the first group 5a. It is also possible, simultaneously to the control of identity data and the updating of group data, to verify that the individual 6a carrying the data medium 1 indeed has boarding rights corresponding to the flight for which he or she is presenting him or herself. On arrival, each traveler 6a presents him or herself at a control area, provided at the entry to the second group 5b, and at which he or she submits his or her data medium 1 to the control. The group data contained in the group zone 4 of the data medium 1 is controlled by a portal forming the group control unit 13 and through which each “incoming” traveler 6a passes. The control operations are performed automatically. The group control unit 13 verifies, on the fly, the territories through/in which the traveler 6a has previously traveled/stayed, warning, if necessary, a security agent 7 for interior flights and the police authorities 7 for international flights.

The device 10 operates similarly when a traveler 6b goes from the second group 5b to the first group 5a. For greater clarity, the updating, entity control and group control units corresponding to this reciprocal operation have not been shown.

### Description of Alternative Embodiments

The second application shown by FIG. 4 is substantially similar to that of FIG. 3. When the traveler 6a leaves the first group 5a, at the departure of the first territory, the group data of the traveler 6a is updated by the updating unit 12 managed by a control agent 8. The identity data of the traveler 6a is controlled by this same control agent 8 by means of an identity control unit 11. On arrival of the traveler 6a in the second group 5b, at the entry to the second territory, a control agent 8 supervises the control, by means of a group control unit 13, of group data contained in the group zone 4 of the data medium 1. In this example, the control operations are performed semi-automatically. If the group data is not validated, a security agent 7 is alerted. The device 10 operates similarly when a traveler 6b goes from the second group 5b to the first group 5a. For greater clarity, the updating, entity control and group control units corresponding to this reciprocal operation have not been shown.

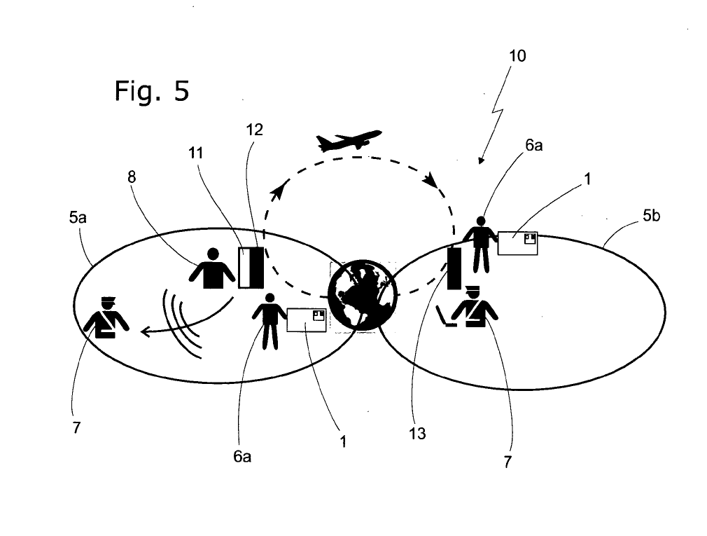

The third application shown in FIG. 5 is substantially similar to that of FIG. 3. It differs therefrom by the fact that the updating 12 and identity control 11 units of the first group 5a managed by a control agent 8 are capable of alerting a security agent 7 in the event of an abnormality. In addition, upon arrival of the traveler 6a in the second group 5b, the group control unit 13 is directly managed by a security agent 7 capable of acting in the event of an abnormality.

According to an embodiment not shown, the entity control device according to the invention also makes it possible to update, as necessary, the identity data, in particular when the traveler leaves one of the groups.

The different embodiments described above may of course be combined, in particular so as to meet the national legislation requirements.

### INDUSTRIAL APPLICABILITY

The data media 1, device 10 and entity control method are advantageously used to control the origin of travelers 6a, 6b and provide means to the competent authorities to act before accepting the entry of a traveler 6a, 6b in their territory or the boarding of a traveler 6a, 6b in a means of transport such as in particular an airplane. It is clear from this description that the invention meets the objectives and that it makes it possible in particular to reliably and precisely preserve the history of territories (group 5a, 5b) previously visited by each traveler 6a, 6b, to quickly and effectively control this history before deciding to provide authorization to said traveler 6a, 6b to change territories and/or to board, these verifications being performed with respect for the individual liberties and confidentiality of data relating to each traveler. The transport is thus secured. Similarly, the interior security of each state is thus better controlled, at least by filtering individuals 6a, 6b authorized to enter this territory. The invention also makes it possible to eliminate the need for paper documents, which are more easily falsifiable and more fragile than the data medium 1 according to the invention. The data medium 1 can, moreover, contain a number of important data items that would require a plurality of paper media if they were inscribed on paper. The invention therefore enables savings of media, reinforced by the fact that the data media 1 are reusable. The invention finally makes it possible to improve the comfort of travelers 6a, 6b for whom the formalities before boarding and before entering a territory are simplified, as they are performed on the fly and by means of a single data medium 1 by fast automated means. The invention also makes it possible to simplify the work of control agents 7 who no longer have to perform document comparison work.

It is understood that the invention may be applied to any other application involving the passage of entities from one group to another. Thus, the concept of group is very broad and may include associations, professional groups, activity clubs and so on.

Similarly, the invention may be used to control packages passing from one storage area to another and of which the history is to be tracked, for example so as to ensure that the packages have not passed through a polluted area. In this case, the data medium may be in the form of a tag fastened to the package, with this tag comprising an electronic chip equipped with identity and group zones.

The invention may also be used for the control of animals passing from one farm to another or to a slaughterhouse and of which the history is to be tracked, for example so as to ensure that the animals have not passed through an area contaminated by a disease. In this case, the data medium may be in the form of an implant inserted under the skin of each animal, with this implant comprising an electronic chip equipped with identity and group zones.

It is understood that the examples described are merely specific illustrations and do not in any way limit the fields of application of the invention. A person skilled in the art will be able to make modifications to the specific examples of embodiments without going beyond the scope of this invention. Thus, the data medium, the device and the entity control method according to the invention may also be used to manage movements of entities between sub-groups contained in different groups or in the same group.

1. Data medium (1) comprising at least one identity zone (3) capable of storing identity data relating to the identity of the entity (6a, 6b) to which is intended to be assigned, wherein said identity data is capable of being accessible only by at least one qualified identity control unit (11), characterized in that it comprises at least one electronic chip (2) equipped with at least one group zone (4) capable of storing group data relating to the belonging of said entity (6a, 6b) to at least one group (5a, 5b), said group data being protected by at least one gate so as to be accessible only by at least one qualified group control unit (13) having an access key for said gate, said group zone (4) being capable of being updated only by means of a qualified updating unit (12) having an access key for said gate, with the updating being performed by the addition of at least one complementary group data item incrementing, without altering, said group data previously stored on the basis of the passage of said entity (6a, 6b) from one group (5a, 5b) to another group (5b, 5a) so as to generate a history of belonging of said entity (6a, 6b) to said successive groups (5a, 5b), with said group zone (4) being capable of preserving said history.

2. Data medium (1) according to claim 1, characterized in that said electronic chip (2) is arranged so that said gate is chosen from the group including at least an optical gate, a magnetic gate or an electronic gate, capable of being opened by an optical, magnetic or electronic key, respectively.

3. Data medium (1) according to claim 2, characterized in that said electronic chip (2) is an RFID chip equipped with said electronic gate.

4. Data medium (1) according to claim 1, characterized in that said group zone (4) is arranged so that said group data is accessible by said qualified group control unit (13), independently of said identity data.

5. Data medium (1) according to claim 1, characterized in that said group zone (4) is capable of storing said group data incrementally, permanently and inalterably.

6. Data medium (1) according to claim 1, characterized in that said identity (3) and group (4) zones are distinct.

7. Data medium (1) according to claim 1, characterized in that it comprises at least one electronic chip (2) equipped simultaneously with said identity (3) and group zones (4).

8. Data medium (1) according to claim 7, characterized in that it is chosen from at least:
a smart card, a passport, a telephone, a bracelet, a watch, a collar, a tag intended to be worn by said entity (6a, 6b), or
an implant, intended to be inserted into said entity (6a, 6b) or into an object associated with said entity (6a, 6b).

9. Data medium (1) according to claim 1, characterized in that said group (5a, 5b) on which said group data is based consists of entities (6a, 6b) having been present, at a given time, in a given geographic territory, and in that said updated group data relates to the crossing by an entity (6a, 6b) of the territorial boundary of each geographic territory, and in that all of said group data constitutes a history of the territorial boundaries crossed.

10. Data medium (1) according to claim 9, characterized in that said group data is chosen from a group including at least a state logo, the ICAO code of an airport, and the date of update.

11. Data medium (1) according to claim 1, characterized in that said group data also comprises the date of its update on said data medium (1).

12. Device (10) for controlling entities, comprising a plurality of data media (1), each data medium (1) comprising identity data relating to the entity (6a, 6b) to which it is assigned, said device (10) comprising control means (11, 13) equipped with at least one identity control unit (11) capable of accessing said identity data, characterized in that it comprises a plurality of data media (1) according to any one of the previous claims, at least one qualified updating unit (12) comprising at least one access key for said gate protecting access to said group data and capable of updating said group data by the addition of at least one complementary group data item incrementing, without altering, said group data previously stored, on the basis of the passage of said entity (6a, 6b) from one group (5a, 5b) to another group (5b, 5a) so as to generate a history of belonging of said entity (6a, 6b) to said successive groups (5a, 5b), with said history being preserved by said group zone (4), in that said control means also comprise at least one qualified group control unit (13) comprising at least one access key for said gate protecting access to said group data and capable of accessing said group data of each entity (6a, 6b) and of controlling it, in that said device (10) comprises alert means coupled at least with said group control unit (13) and capable of triggering an alert on the basis of said group data controlled by said group control unit (13).

13. Device (10) according to claim 12, characterized in that said access key for said updating unit (12) and said group control unit (13) is chosen from the group including at least an optical access key, a magnetic access key or an electronic access key capable of opening an optical, magnetic or electronic access gate, respectively.

14. Device (10) according to claim 13, characterized in that at least one of said updating unit (12) or group control unit (13) comprises an RFID microprocessor equipped with said electronic key.

15. Device (10) according to claim 12 characterized in that said updating unit (12) is geographically remote from said group control unit (13).

16. Device (10) according to claim 12, characterized in that said updating unit (12) and said group control unit (13) are respectively provided in at least one location for passage of said entities (6a, 6b) leading to the entry into/departure from at least one first/second geographic territory, with each geographic territory defining one of said groups (5a, 5b).

17. Device (10) according to claim 16, characterized in that said location for passage of said entities (6a, 6b) is chosen from at least airports, ports, train stations and road border stations.

18. Device (10) according to claim 12, characterized in that said group control unit (13) is coupled with blocking means capable of preventing the passage of said entity (6a, 6b) from one group (5a, 5b) to another group (5b, 5a) on the basis of said controlled group data.

19. Device (10) according to claim 18, characterized in that said blocking means are chosen from the group including at least a door, a barrier or an airlock.

20. Device (10) according to claim 12, characterized in that said identity control unit (11) is combined with at least one of said group control (13) and/or updating (12) units.

21. Method for controlling entities (6a, 6b) in which said entity (6a, 6b) is assigned at least one data medium comprising data relating to the identity of said entity (6a, 6b), characterized in that
a data medium (1) comprising at least one identity zone (3) capable of storing identity data relating to the identity of the entity (6a, 6b) to which is intended to be assigned, wherein said identity data is capable of being accessible only by at least one qualified identity control unit (11), characterized in that it comprises at least one electronic chip (2) equipped with at least one group zone (4) capable of storing group data relating to the belonging of said entity (6a, 6b) to at least one group (5a, 5b), said group data being protected by at least one gate so as to be accessible only by at least one qualified group control unit (13) having an access key for said gate, said group zone (4) being capable of being updated only by means of a qualified updating unit (12) having an access key for said gate, with the updating being performed by the addition of at least one complementary group data item incrementing, without altering, said group data previously stored on the basis of the passage of said entity (6a, 6b) from one group (5a, 5b) to another group (5b, 5a) so as to generate a history of belonging of said entity (6a, 6b) to said successive groups (5a, 5b), with said group zone (4) being capable of reserving said history; and
a device (10) for controlling entities, comprising a plurality of data media (1), each data medium (1) comprising identity data relating to the entity (6a, 6b) to which it is assigned, said device (10) comprising control means (11, 13) equipped with at least one identity control unit (11) capable of accessing said identity data, characterized in that it comprises a plurality of data media (1) according to any one of the previous claims, at least one qualified updating unit (12) comprising at least one access key for said gate protecting access to said group data and capable of updating said group data by the addition of at least one complementary group data item incrementing, without altering, said group data previously stored, on the basis of the passage of said entity (6a, 6b) from one group (5a, 5b) to another group (5b, 5a) so as to generate a history of belonging of said entity (6a, 6b) to said successive groups (5a, 5b), with said history being preserved by said group zone (4), in that said control means also comprise at least one qualified group control unit (13) comprising at least one access key for said gate protecting access to said group data and capable of accessing said group data of each entity (6a, 6b) and of controlling it, in that said device (10) comprises alert means coupled at least with said group control unit (13) and capable of triggering an alert on the basis of said group data controlled by said group control unit (13)
are used, said method also comprising at least the following steps:
the updating, recording and storage on said data medium (1) of group data relating to the change in group (5a, 5b) of said entity (6a, 6b), in order to create, by means of updates, a history of said groups (5a, 5b) to which said entity (6a, 6b) has belonged,
the control and filtering of said group data of said entity (6a, 6b) in order to verify said history and, on the basis of said controlled group data, to validate said control or not.

22. Method according to claim 21, characterized in that at least one of said steps of updating, controlling and filtering is performed, in a location of passage of said entities leading to the entry into/departure from at least one first/second group (5a, 5b).

23. Method according to claim 21, characterized in that it includes at least one preliminary step of defining criteria during which control criteria for positive/negative admissibility of an entity (6a, 6b) in a group (5a, 5b) are defined, and in that, during said filtering step, it is not possible to validate, without an additional step, the passage of said entities (6a, 6b) of which the controlled group data do not correspond/correspond to said control criteria for positive/negative admissibility.

24. Method according to claim 21, characterized in that, when said controlled group data are not validated, at least one of the following steps is performed:
the blocking of the change in entity group (5a, 5b) by said entity (6a, 6b),
the transmission of an alert signal.
